(19) United States
(12) Patent Application Publication
(10) Pub. No.: US 2021/0130023 A1
(43) Pub. Date: May 6, 2021

(54) PACKAGING METHOD

(71) Applicant: Sealed Air Corporation (US), Charlotte, NC (US)

(72) Inventors: Preston Chad Stephens, Charlotte, NC (US); Brian Vilag, Fort Mill, SC (US)

(21) Appl. No.: 16/468,453

(22) PCT Filed: Dec. 15, 2017
(86) PCT No.: PCT/US2017/066564

§ 371 Date: Jun. 11, 2019

Related U.S. Application Data
(60) Provisional application No. 62/434,570, filed on Dec. 15, 2016.

(51) Int. Cl. B65B 61/26; B65B 5/06; B65B 55/20; B65B 61/20; G06Q 30/02; G06Q 30/06

(52) U.S. Cl. CPC B65B 61/26; B65B 5/06; G06Q 30/0635; B65B 61/202; G06Q 30/0251; B65B 55/20

(57) ABSTRACT

Methods and systems are capable of being used to package products from a selection of products. A collection of one or more products is provided from the selection of products. Information is received, where the information includes one or more of recipient-specific information associated with an intended recipient of the collection and product-specific information associated with the collection. Targeted information is selected for the collection based on the received information. The targeted information is affixed on a protective packaging material to create a targeted protective packaging material. A package is created by combining the targeted protective packaging material and the collection.

### BACKGROUND

The presently disclosed subject matter relates to methods of packaging a collection of one or more products from a selection of products utilizing protective packaging materials that incorporate targeted information (e.g., targeted advertisement information), to the packaging systems and machines for performing same, and to the delivery of targeted information to the system.

Protective packaging materials (e.g., inflated structures such as cushions or sheets, foam-in-bag materials, and crumpled paper dunnage) can be used to package products, for example by wrapping the one or more products in the material and placing the wrapped product in a shipping carton, or for example by placing the protective packaging material inside a shipping carton along with the one or more products to be shipped. The protective packaging material protects the packaged item by absorbing impacts that may otherwise be fully transmitted to the packaged product during transit, and may also restrict movement of the packaged products within the carton to further reduce the likelihood of damage to the one or more products.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a method can be performed to packaging a selection of products. The method includes: providing a collection of one or more products from the selection of products, receiving information selected from one or more of: recipient-specific information associated with an intended recipient of the collection or product-specific information associated with the collection, selecting targeted information for the collection based on the received information, affixing the targeted information on a protective packaging material to create a targeted protective packaging material, and creating a package combining the targeted protective packaging material and the collection.

In one example, the method includes repeating the steps for the remaining products of the selection of products. In another example, the selecting includes selecting the targeted information from a database of stored information. In another example, the affixing includes affixing the targeted information on a component of the protective packaging material to create a targeted protective packaging component and subsequently producing the targeted protective packaging material to include the targeted protective packaging component. In another example, the affixing includes producing the protective packaging material to include a protective packaging material component and subsequently affixing the targeted information on the component to create the targeted protective packaging material. In another example, the method further includes shipping each package to the corresponding intended recipient of the collection of one or more products.

In another example, the method further includes providing a machine adapted to produce protective packaging material by combining one or more components of protective packaging material, where the machine includes a source of the one or more components of the protective packaging material and a printer adapted to receive the targeted information and to print the targeted information on a component of the protective packaging material. In another example, the printer comprises a print and apply labeling system. In another example, the protective packaging material comprises an inflatable structure. In another example, the protective packaging material comprises an inflatable structure, the machine is adapted to inflate the inflatable structure with an inflation fluid and to close the inflatable structure to retain the inflation fluid, and the printer is adapted to print the targeted information on the inflatable structure. In another example, the inflatable structure includes top and bottom sheets sealed together by transverse seals to define a series of inflatable chambers having an opening between the terminal ends of the transverse seals and proximate a longitudinal edge of the web for receiving inflation fluid. In another example, the printer is adapted to print the targeted information on one or more of the top and bottom sheets of the inflatable structure. In another example, the inflatable structure is a dunnage cushion.

In another example, the protective packaging material includes a frame defining one or more foldable flaps and a remainder portion of the frame and a sheet affixed to the one or more foldable flaps. In another example, the protective packaging material includes a frame defining one or more foldable flaps and a remainder portion of the frame and a sheet, where the machine is adapted to affix the sheet to the one or more foldable flaps and the printer is adapted to print the targeted information on one or more of the frame and the sheet. In another example, the protective packaging material comprises a foam-in-bag assembly.

In another example, the protective packaging material includes a bag formed from one or more films and one or more foam precursors or the foam generated by reaction of the one or more foam precursors. In another example, the machine is adapted to provide the bag, dispense the one or more foam precursors into the bag, and close the bag to retain the one or more foam precursors or the foam generated by reaction of the one or more foam precursors, and the printer is adapted to print the targeted information on the one or more films of the bag.

In another example, where the receiving step further includes sensing one or more products of the collection using a product reader configured to generate detected information corresponding to the sensed one or more products of the collection and accessing the recipient-specific information or the product-specific information based on the detected product information. In another example, the detected product information comprises digital information generated by one or more of a bar code scanner, a laser sensor, a vision system, a digital camera, an ultraviolet sensor, and a radio frequency identification reader. In another example, the recipient-specific information includes one or more of destination location, shipping information, name, address, shipping code, carrier bar code, tracking information, postal code, zip code, postage information, gender, marital status, age, religious affiliations, occupation, language, education, socio-economic status, employment, income, mobility, home ownership, debts, ethnicity, life cycles, nationality, or family size, climate or weather at the intended destination, purchasing history, and purchasing patterns. In another example, wherein the product-specific information includes one or more of weight information, order information, order number, invoice information, content information, the number of items associated with the product, the type of items associated with the product, a description of the product, the category of product, the end-use of the product, the sales price of the product, the cost of the product, and manifest information.

In another example, the targeted information includes targeted advertisement information. In another example, the method further includes using a computer system comprising a processor configured to receive the detected product information, access a database having one or more of (i) the recipient-specific information associated with the detected product information and (ii) the product-specific information associated with the detected product information, receive targeted advertising information associated with the recipient-specific information or the product-specific information based on advertisement selection criteria, and provide the targeted advertisement information to the printer for printing on the protective packaging material. In another example, the processor is further configured to associate targeted advertising information with the recipient-specific information or the product-specific information based on advertisement selection criteria. In another example, the computer processor is configured to operatively control the printer to print the targeted advertisement information on the component of the protective packaging material to create the targeted protective packaging component. In another example, the advertisement selection criteria determines the targeted advertisement information based on the product-specific information. In another example, the advertisement selection criteria determines the targeted advertisement information based on the recipient-specific information. In another example, the targeted advertising information includes one or more of promotions, sales, discounts, coupons, pricing, availability, timing, physical locations, online locations, product or services performance or descriptions, slogans, trademarks, service marks, and trade names.

In another embodiment, a packaging system is usable to package a collection of one or more products from a selection of products. The system includes a printer, at least one processor and at least one memory storing computer program code, wherein the at least one memory and the computer program code are configured to, with the at least one processor, cause the system to: store information that is adaptable to be printed, select targeted information from the information based on received information comprising one or more of: (i) recipient-specific information associated with an intended recipient of the collection and (ii) product-specific information associated with the collection, and cause the printer to print the selected targeted information on a component of the protective packaging material or on a label for application to the component. The system further includes a machine adapted to produce targeted protective packaging material to include the component of protective packaging material having the selected targeted advertisement information.

In one example, the system further includes a scanner adapted to provide the received information from the collection of one or more products, wherein the at least one memory and the computer program code are configured to, with the at least one processor, receive the information provided by the scanner. In another example, the system further includes a packing station adapted to create a package combining the targeted protective packaging material and the collection.

### BRIEF DESCRIPTION OF THE DRAWING

The foregoing aspects and many of the attendant advantages of the disclosed subject matter will become more readily appreciated as the same become better understood by reference to the following detailed description, when taken in conjunction with the accompanying drawings, wherein:

FIG. 1 is an overview of a system that can be used to practice some embodiments of the present invention;

FIG. 2 is a block diagram of a control computing entity of FIG. 1;

FIG. 3 is a flowchart of various processes and procedures for packaging according to some embodiments of the present invention;

FIG. 3A is a flowchart providing detail regarding one variation of embodiments of the affixing step of FIG. 3;

FIG. 3B is a flowchart providing detail regarding another variation of embodiments of the affixing step of FIG. 3;

FIG. 4 is a representative side elevation view of machine for producing protective packaging material as inflated structures, namely inflated containers;

FIG. 5 is a representative side elevation view of machine for producing targeted protective packaging material as inflated structures, namely printed inflated containers comprising targeted advertisement information;

FIG. 6 is a representative perspective view of the machine of FIG. 5;

FIGS. 7A to 7C are representative side elevation views of machines for producing targeted protective packaging material as inflated structures, namely printed inflated containers comprising targeted advertisement information;

FIG. 8 is a representative top down view of targeted protective packaging material as an inflated structure, namely printed inflated container; and

FIG. 9 is a representative perspective view of a packing station.

### DETAILED DESCRIPTION

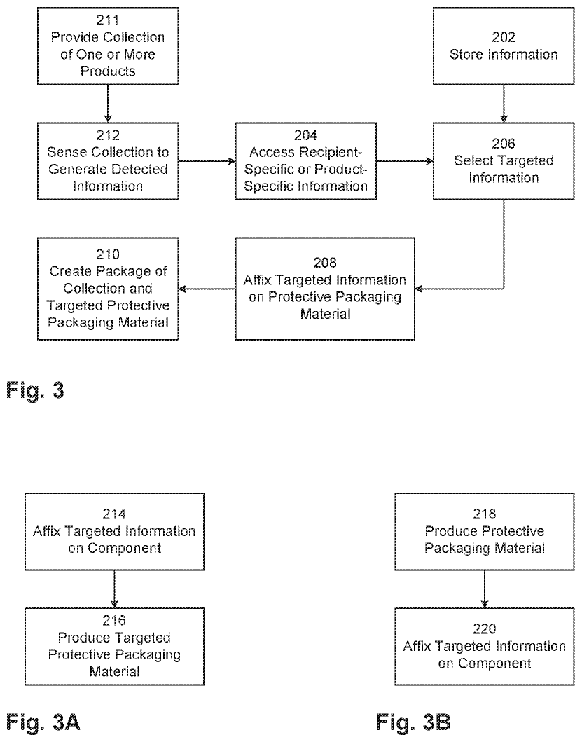

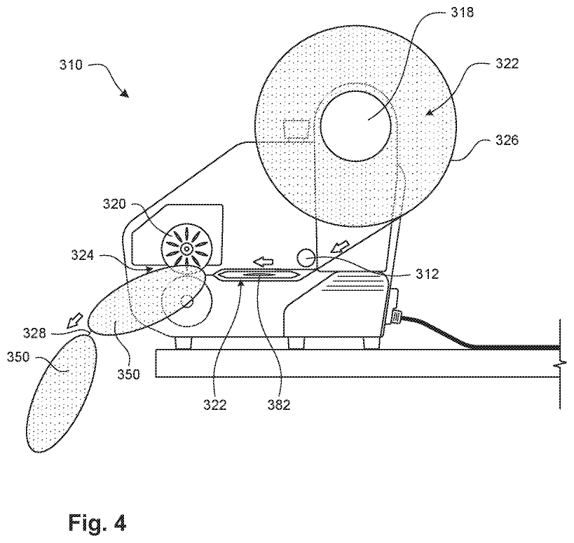

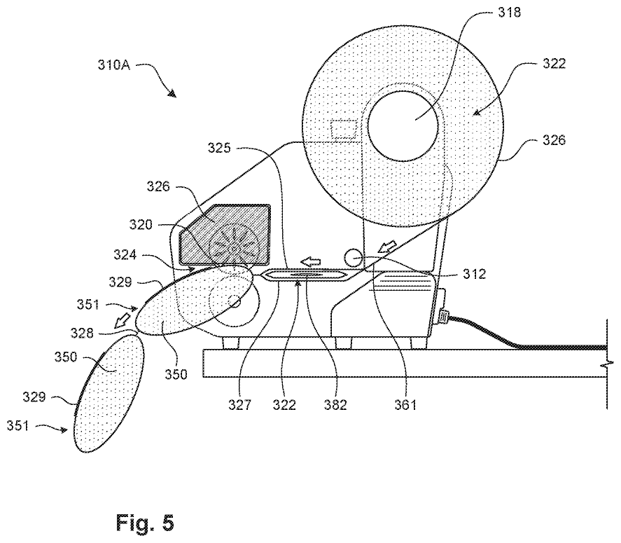

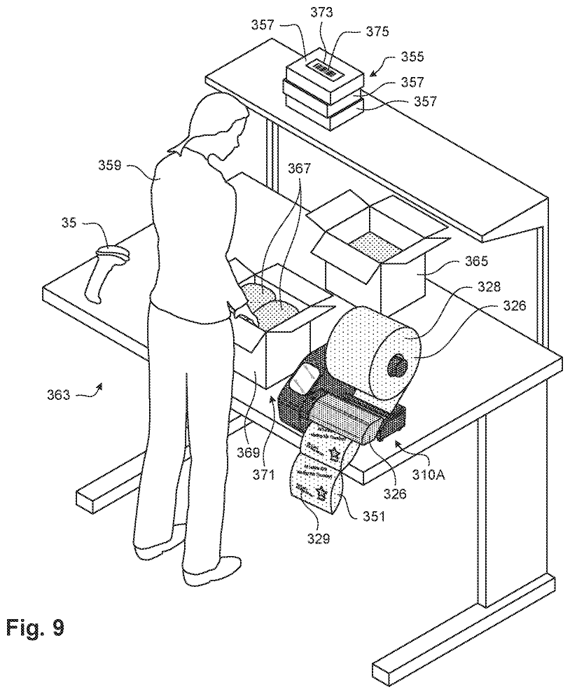

Various embodiments of the presently disclosed subject matter are directed to a method of packaging a collection of one or more products from a selection of products. (FIG. 3, FIG. 9.)

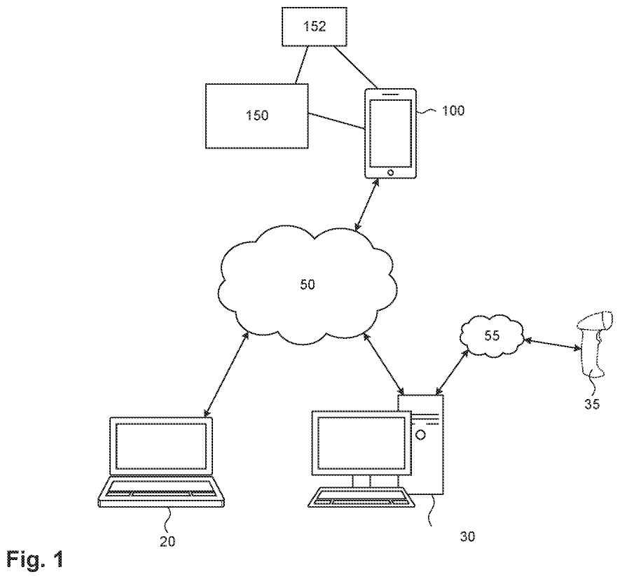

FIG. 1 illustrates an example embodiment of a system that may implement the presently disclosed subject matter. The system may include one or more control computing entities 100, one or more machines 150 adapted to produce protective packaging material used in making targeted protective packaging material, one or more printers 152 adapted to receive targeted information used in making targeted protective packaging material, one or more database computer entities 20, and one or more package control systems 30, all as described herein in more detail. The one or more printers 152 may be integral with, or separate from, the one or more machines 150. The one or more control computing entities 100, one or more database computer entities 20, one or more package control systems 30, and one or more scanners 35 may communicate with each other and/or a variety of other computing entities via one or more wired or wireless networks, such as networks 50, 55. In an example embodiment, a package control system 30 may be in wired or wireless communication with one or more scanners 35 via wired or wireless network 55 (e.g., a 3G network, the Internet, an internal network, a proprietary network, a secured network, and/or the like). As used herein, “scanner” refers to a reader device (e.g., product reader) such as an automated identification and data capture device, such as a bar code scanner, optical scanner, computer vision device, a laser sensor, a vision system, a digital camera, an ultraviolet sensor, and a radio frequency identification (RFID) reader. The product reader 35 may be configured to generate detected information corresponding to the one or more of the products of the collection that are sensed by the product reader, and to communicate the detected information to the system.

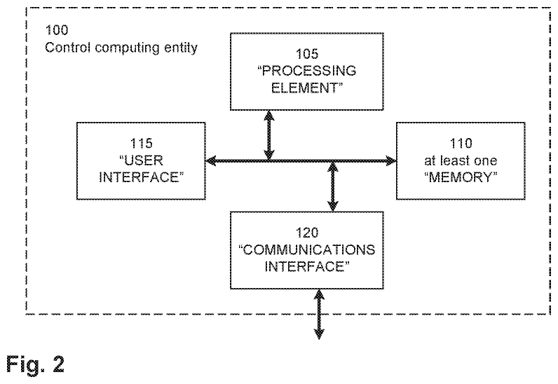

FIG. 2 provides a block diagram of an exemplary control computing entity 100. For example, a control computing entity 100 may comprise a processing element 105, memory 110, a user interface 115, a communications interface 120, and/or the like. The control computing entity 100 may be in direct wired or wireless communication with one or more machines 150 for making protective packaging material and/or with the package control systems 30. The control computing entity 100 may be an integrated or integral part of the machine 150 and/or the printer 152, and may perform various functions as the controller thereof. For example, the control computing entity 100 may be configured to receive signals from one or more sensors of the machine 150 and provide machine instructions to the machine 150 such that the machine makes one or more protective packaging materials of a predetermined amount or sequence. Example embodiments of the packaging material making machine 150 may comprise a combination of sensors used to determine if the machine is finished making a current protective packaging material and is ready to make a next protective packaging material. For example, one of the sensors may be a foot switch that the user may operate to provide various input, as described herein. In various embodiments, the sensors may comprise one or more infrared (IR) sensors, optical sensors, Hall Effect sensors, capacitive sensors, limit switches, pressure sensors, and electrical current sensors.

The control computing entity 100 may be configured to control the machine 150 for making the protective packaging material (e.g., a predetermined sequence of one or more protective packaging materials) and/or may be configured to control the printer 152.

Example embodiments of a control computing entity 100 are described in more detail herein. The control computing entity 100 may also or alternatively be in direct wired or wireless communication with one or more printers 152 to transmit targeted information to the printers 152 to make targeted protective packaging material. The control computing entity 100 may be an integrated or integral part of the printer 152 and perform various functions as the controller thereof. For example, the control computing entity 100 may receive signals from one or more sensors of the printer 152 and provide machine instructions to the printer 152 such that the printer makes one or more targeted protective packaging materials having affixed targeted advertisement information. For example, example embodiments the printer 152 may comprise a combination of sensors used to determine if the printer is finished printing a current targeted advertisement information, and is ready to print a next targeted advertisement information. The sensors may be one or more of the sensors described herein.

Packaging control system 30 may be configured to perform one or more of the functions described herein as performed by the control computing entity 100 (e.g., storing advertisement information, selecting targeted advertisement information, controlling the machine and/or printer). For example, the control computing entity 100 may store or relay information received from the package control system 30 to the printer 152 or machine 150. For example, package control system 30 may be configured to provide control instructions for the machine 150 for making the protective packaging material and/or for the printer 152 to print the targeted advertising information, and control computing entity 100 may be configured to receive and relay those control instructions.

### Protective Packaging Materials and Machines for Making Same

In various embodiments, the protective packaging material may comprise one or more of, for example, inflated structures, foam-in-bag or foam-in-place packaging, paper dunnage, and suspension and/or retention packaging materials.

Inflated structures include inflated webs, cushions, pillows, and other inflated containers used in packaging for dunnage, protective, and/or bracing functions. Inflated structures includes, for example, a web or string of inflated containers (i.e., cushions), for example, as described in U.S. Patent Application Publ. 2015/0075114 A1 and U.S. Pat. Nos. 8,567,159; 8,554,363; 8,020,358; 7,950,433; 7,225,599; and 6,651,406, each of which is incorporated herein in its entirety by reference; and with respect to web material having sequential transverse rows of inflated protrusions, such as rows of inflated “bubbles” for example, web materials as described for example in one or more of U.S. Pat. Nos. 6,800,162; 6,982,113; 7,220,476; 8,567,159; 8,978,345; and 8,991,141; each of which is incorporated in its entirety by reference; and with respect to air cellular cushioning material, as described, for example, in one or more of U.S. Pat. Nos. 4,314,865; 4,412,879; 4,417,936; 4,427,474; 4,950,354; 5,116,444; and 5,665,456, each of which is incorporated herein in its entirety by reference. The term “inflated” in the context of inflated structure includes air-containing containers or cells that contain or capture air at ambient pressure. These references also disclose exemplary machines for producing the inflated structures protective packaging material.

Foam-in-bag packaging and foam-in-place packaging includes, for example, materials described in one or more of U.S. Pat. App. Ser. No. 62/167,530 filed May 28, 2015, U.S. Pat. App. Pub. 2007-0252297 A1, and U.S. Pat. Nos. 3,687,370; 3,945,569; 4,023,733; 4,159,079; 4,426,023; 5,186,905; 5,255,847; 5,791,522; 5,950,875; 6,811,059; 6,929,193; and 6,996,956; 4,800,708; 4,854,109; 5,027,583; 5,335,483; 5,376,219; 5,590,816; 5,709,317; 6,003,288; 6,472,638; 6,675,557; 7,607,911; 8,869,859; 5,699,902; 6,272,813; 5,996,782; 5,899,325; 6,712,201; 6,862,868; each of which is incorporated herein in its entirety by reference. These references also disclose exemplary machines (e.g., dispensers) for producing foam-in-bag and foam-in-place protective packaging material.

Paper dunnage includes, for example, materials described in one or more of U.S. Patent App. Publications 2013/313277 A1; 2008/0153685 A1 2016/0001519 A1; 2009/0023570 A1 2009/0082187 A1; 2011/0053743 A1 and U.S. Pat. Nos. 5,607,383; 6,610,001; 5,637,071; 6,077,209; 5,3870,173; 6,918,489; 5,882,767; 7,614,994; 5,868,657; 6,217,498; 6,026,632; 5,749,821; 6,475,130; 6,758,801; 6,200,251; 8,419,606; U.S. Pat. Nos. 7,740,573; 5,709,642; 7,083,560; 5,924,971; 6,277,459; 6,033,353; 5,902,223; 9,321,235; 6,676,589; 8,177,701; 5,658,229; 6,783,489; 7,955,245; 6,017,299; 6,626,813; 7,803,100; 5,938,580; 7,651,455; 6,910,997; 8,419,606; 6,168,559; 8,900,111; 8,641,591; 8,303,475; 7,258,657, 6,783,489, 6,019,715; 8,845,504; 8,267,848; and 8,388,508, each of which is incorporated herein in its entirety by reference. These references also disclose exemplary machines for producing paper dunnage protective packaging material.

Suspension and/or retention packaging materials include, for example, materials described in one or more of U.S. Pat. Nos. 4,852,743; 4,923,065; 5,071,009; 5,287,968; 5,388,701; 5,678,695; 5,893,462; 6,010,006; 6,148,590; 6,148,591; 6,289,655; 6,302,274; 6,311,844; and 6,899,229; each of which is incorporated herein in its entirety by reference; and in International Pat. App. Publ. No. WO 2016/040787 and International Pat. App. Serial No. PCT/US2016/028758 filed Apr. 22, 2016, each of which is incorporated herein in its entirety by reference. Suspension packaging materials are configured to suspend the packaged product between two suspension sheets each attached to opposing frames sized to fit within a corresponding box. Retention packaging materials are configured to retain a packaged product between a sheet and a rigid backing frame to which the sheet is attached. These references also disclose machines for producing suspension and/or retention protective packaging materials.

### Printers

Useful printers 152 include, for example, digital printing machines such as inkjet printers, laser printers, and thermal transfer printers, for example adapted for on-demand printing. These types of printers may deposit pigment or toner onto a wide variety of substrates including paper and plastic (polymeric based) films. Useful printers 152 could also include other types of printers, such as chemical etchers that form marks on a surface via a chemical etching process.

The printer may include one or more digital printheads (e.g., an inkjet printhead), and for example, a plurality of printheads to provide for full color printing of the targeted information onto a component of protective packaging material (e.g., a polymeric film, paper, and cellulosic-based materials such as cardboard, corrugated cardboard, paperboard, and chipboard). Suitable digital printheads are known in the art. The deposited ink may be radiation curable (UV-curable, e-beam curable), as are known in the art, in which case the printer may include a suitable curing device to cure the printed inks (e.g., a UV source or electron beam source). The component of the protective packaging material may be subjected to a pre-treatment before printing (e.g., corona or plasma treatment) to increase the surface energy of the web to allow for a greater bond between the ink and the material of protective packaging material.

### Exemplary System Operation

In various embodiments, the control computing entity 100 may be configured to (1) store information that is adaptable to be printed, (2) select targeted information from the stored information based on received information comprising one or more of: (i) recipient-specific information associated with an intended recipient of the collection and (ii) product-specific information associated with the collection, and (3) cause a printer to print the selected targeted information on a component of the protective packaging material.

FIG. 3 provides a flowchart of embodiments of the presently disclosed subject matter. Starting at block 202, information adaptable to be printed is stored. For example, the control computing entity 100 may store the information. For example, the control computing entity 100 may comprise memory 110 or the like configured for storing information. In other example embodiments, the information may be stored by database computer entity 20, package control system 30, and/or other computing device in communication with network 50 (e.g., a warehouse management system), in addition to and/or in place of information being stored locally by the control computing entity 100. In such example embodiments, the control computing entity 100 may request information (e.g., targeted advertisement information) from the database computer entity 20, package control system 30, or other computing device, as appropriate, and receive the information (e.g., targeted advertisement information) in volatile memory for later execution (e.g., in affixing, for example, printing) the targeted advertisement information. Examples of information that is adaptable to be printed include targeted advertisement information, user-specified information (e.g., user-specified messages, user-specified images, etc.), or any other type of information.

Advertising information includes information, for example, to build consumer awareness and/or loyalty, to teach, to influence preferences, and/or to incentivize, and includes, for example, information such as, or related to, messages, promotions, sales, discounts, coupons, pricing, availability, timing, locations (physical or online), product or services performance or descriptions, slogans, trademarks, service marks, and trade names, all of which may be presented or applied in any form such as textual, graphical, pictorial, audio, or video.

User-specified information may include any information provided or selected by a user. For example, when purchasing a product as a gift for a recipient, the user may select one or more messages from a set of predetermined messages, such as “Congratulations!”, “Happy Birthday!”, “Get well soon”, or any other such predetermined message. In another example, when purchasing a product as a gift for a recipient, the user may input a message, such as “Congratulations, Jenny!”, “Happy Birthday, Steve!”, or any other user-inputted message. In another example, a user may select an image, such as one or more images from a set of predetermined images associated with a particular holiday or time of year (e.g., a snowflake, a beach scene, a pumpkin, etc.), a symbol of a particular occasion (e.g., wedding bells, graduation cap, etc.), or any other type of predetermined image. In another example, a user may provide an image (e.g., upload the image, point to an image on a social network, etc.), such as an image of the user and the user's parent for a Mother's Day gift or a Father's Day gift, an image of the recipient for any type of gift, or any other image. In general, user-specified information may contain any combination of user-selected and/or user-provided textual information, image information, or any other type of information.

At block 211, a collection of one or more products is provided from a selection of products. For example, order processing may include the functions picking and packaging a collection of one or more products for shipment to a specified location to fulfill an order. The activities of order picking and assembling the collection of one or more products into a shipment often occurs at a distribution center (e.g., warehouse). The distribution center may be stocked with a selection of products for distribution to retailers or directly to consumers, for example in fulfillment of orders generated by electronic commerce (i.e., e-commerce). Providing a collection of one or more products from the selection of products (available, for example, in a warehouse) may involve order picking, for example, where one or more products are selected and collected to fulfill an order. There are several ways of accomplishing order picking, for example, piece picking, zone picking, wave picking, automated sorting systems (e.g., conveyor system), and pick-to-box. Generally, these may involve an operator or picker facilitating the collecting of the products for the order or by an automated storage and retrieval system (ASRS) or other automated dispenser providing a collection of one or more products to fulfill an order.

At block 212, the collection of one or more products from the selection of products is sensed, for example using scanner 35 as described herein, to generate detected information corresponding to the sensed one or more products of the collection. The collection of one or more products may include a machine-readable code or symbol or other device or indicia for scanner 35 to sense in order to provide detected information for accessing the product-specific information and/or the recipient-specific information. The collection of one or more products may include an accompanying informational item such as a printed sheet comprising machine-readable or scannable information for sensing by a scanner to provide the detected information. The scanner 35 may be adapted to sense a product code on such accompanying informational item. The scanner 35 may comprise, for example, a digital camera or similar scanner, to provide the detected information (i.e., a digital image).

At block 204, the detected information (i.e., input) is received and used to access recipient-specific information and/or product-specific information. For example, the control computing entity 100 may receive the detected information, determine that the detected information relates to product-specific information, and select or access the corresponding product-specific information. The control computing entity 100 may determine that the detected information relates to recipient-specific information, and select or access the recipient-specific information. For example, the control computing entity 100 may comprise a processing element 105, user interface 115, communications interface 120, and/or the like configured for receiving the detected information and selecting or accessing recipient-specific and/or product-specific information in response to the detected information. The recipient-specific information and/or product-specific information may be accessed for receipt from information stored on memory 110, on database computer entities 20, on package control systems 30, and/or the like. The detected information from the sensing of the collection may itself provide sufficient information to embody receipt of the recipient-specific information and/or the product-specific information for use in block 206 without the need for further selection or access.

In various embodiments, the control computing entity 100 may communicate any of one or more of the detected information, the product-specific information, and the recipient-specific information to one or more of database computer entity 20, package control system 30, or other computing device in communication with network 50 or 55, where any of the database computer entity 20, package control system 30, or other computing device in communication with network 50 may determine, for example, that the detected information relates to product-specific information or to recipient-specific information and select or access the corresponding product-specific information or recipient-specific information, using, for example, a processing element to receive the detected information and select or access (i.e., receive) the recipient-specific and/or product-specific information from that stored on a memory in response to the detected information. In the embodiments where control computing entity communicates the product-specific information and/or the recipient-specific information, any of the database computer entity 20, package control system 30, or other computing device in communication with network 50 or 55 may receive the corresponding product-specific information or recipient-specific information, using, for example, a processing element to receive the recipient-specific and/or product-specific information for subsequent use.

Recipient-specific information may include one or more of destination location, shipping information, name, address, shipping code, carrier bar code, tracking information, postal code, zip code, postage information, gender, marital status, age, religious affiliations, occupation, language, education, socio-economic status, employment, income, mobility, home ownership, debts, ethnicity, life cycles, nationality, or family size, climate or weather at the intended destination, purchasing history, and purchasing patterns. Recipient-specific information may also include user-specified information, such as textual information or image information provided or selected by a user.

Product-specific information associated with the collection of one or more products from the selection of products (i.e., associated with the one or more products of the collection) may include one or more of weight information, order information (e.g., order number, invoice information), and content information (e.g., such as the number and/or type of items associated with the product, a description of the product, and manifest information), the category of product, the end-use of the product, the sales price of the product, the cost of the product, and manifest information.

At block 206, targeted information is selected from the stored information of block 202 based on and/or in response to the recipient-specific information and/or the product-specific information received via block 204. For example, the control computing system 100 may select targeted information from the stored information based on and/or in response to the received recipient-specific and/or product-specific information. For example, the control computing system 100 may comprise a processing element 105 configured for receiving the recipient-specific information and/or the product-specific information and selecting targeted information from the stored information based on and/or in response to the received information. For example, if the received input comprises recipient-specific information associated with an intended recipient of the collection, the controlled computing system 100 may be configured to selected targeted information from the stored information based on the received recipient-specific information. In particular, if user-specified information has been provided with the purchase of the collection, the controlled computing system 100 may retrieve the user-specified information. Also by way of example, if the received information comprises product-specific information associated with the collection of one or more products, the control computing system 100 may be configured to select targeted information from the stored information based on the product-specific information. In either or both cases, for example, the selected targeted information may be accessed from the stored information of any of memory 110, database computer entities 20, package control systems 30, and/or the like.

In other example embodiments, any of the database computer entity 20, package control system 30, or other computing device in communication with network 50 or network 55 may select targeted information from the stored information based on and/or in response to the recipient-specific and/or product-specific information, using, for example, a processing element configured for receiving the recipient-specific information and/or the product-specific information, selecting targeted information from the stored information based on and/or in response to the received information, and communicating the targeted advertisement information, for example to control computing entity 100 via network 50.

For example, if the recipient-specific information indicates that the intended recipient of the collection is a man over 60 years old, then the selected targeted information may relate to promotion of a brand of vitamins or supplements that support prostate health (which may be declining for men over 60 years old).

For example, if the product-specific information indicates that the collection relates to a particular brand of shoes, then the selected targeted information may be a promotional slogan for the brand of shoes, or may promote a brand of socks that would go well with the shoes.

Also by way of example, if the product-specific information indicates that the collection relates to basketball equipment, and the recipient-specific information indicates the recipient lives in a particular city or zip code, then the selected targeted information may relate to the promotion of a professional basketball team near the particular city or zip code, and the availability of a season ticket package for purchase to see the team play.

At block 208, the selected targeted information is affixed to the protective packaging material to create a targeted protective packaging material. This affixing step of block 208 may occur as set forth in FIG. 3A, where at block 214 the targeted information is affixed on a component of the protective packaging material to create a targeted protective packaging component. Subsequently at block 216 the targeted protective packaging material is produced to include the targeted protective packaging component. The term “producing” includes assembling, sealing, inflating, etc. as described herein.

The affixing step of block 208 may occur as set forth in FIG. 3B, where at block 218 the protective packaging material is produced to include a protective packaging material component. Subsequently at block 220, the targeted information is affixed on the component of the protective packaging material to create the targeted protective packaging material. The term “affixing” includes printing, labeling, etc. as described herein.

For example, the targeted information may be provided to a printer to cause the printer to affix the targeted information on a protective packaging material (e.g., a predetermined sequence of one or more packing materials). For example, the control computing entity 100 may provide the targeted information to the printer 152 with printer instructions to cause the printer to affix the targeted information to the protective packaging material (e.g., a predetermined sequence of protective packaging material). For example, the control computing entity 100 may comprise a processing element 105, communications interface 120, and/or the like configured for providing the targeted advertising information (and optionally printer instructions) to the printer 152, thereby causing the printer to make a predetermined sequence of targeted protective packaging material. For example, the printer 152 may affix the targeted information on a component of the protective packaging material to create a targeted protective packaging component that is subsequently assembled by machine 150 into the targeted protective packaging material to include the targeted protective packaging component. The printer 152 may affix the targeted information on a component of the protective packaging material that has already been assembled or produced by machine 150 into protective packaging material, thereby creating the targeted protective packaging material.

Also by way of example, the targeted information may be provided to a labeling unit (e.g., a print and apply system) configured to affix (e.g., print via a printer) the targeted information on a label and apply the printed label (e.g., by adhesive) to the protective packaging material (e.g., a component thereof).

At block 210, a package is created to combine the targeted protective packaging material and the corresponding collection of one or more products. For example, an operator at a packaging or packing station may place the collection of one or more products into a box along with the targeted protective packaging material, and seal or tape the box closed. In another example, an automated packaging system forms, without the need for human intervention, a package (e.g., a box, a mailer, a film bag) that includes the collection of one or more products along with the targeted protective packaging material.

The control computing entity 100 and/or package control system 30 may be configured to cause the generation of the targeted protective packaging material so that it is available at the packing station at a time similar to the arrival of the corresponding collection of the one or more products at the packing station where the package is created. In another embodiment, the control computing entity 100 may be configured to cause the generation of the targeted protective packaging material with predetermined delays (e.g., three seconds, six seconds) between the sequential generation of targeted protective packaging materials. For example, the predetermined delay may be determined such that it is expected that the packing operator will be ready to use the subsequent targeted packaging material as soon as or shortly after it is available.

### Inflated Structures System

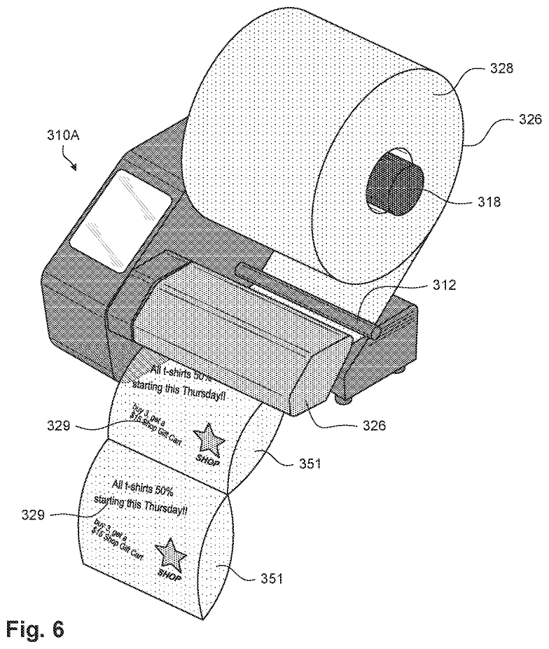

We turn now to embodiments where the protective packaging material and machine for making same relates to inflated structures (e.g., inflated webs, cushions, pillows, and other inflated containers and air-cellular cushioning materials), for example as described in more detail by the incorporated references. By way of a general representative illustration, FIG. 4 shows a machine 310 for producing inflated containers 350 from web 326 of inflatable containers by inflating and sealing the inflatable web 326. The machine 310 includes a web conveyance system 320 for conveying the web of inflatable containers from the roll, around the tension and guide rod 312 and past inflation nozzle 382. Machine 310 further includes a spool 318 for rotatively supporting a roll 328 of the inflatable web, and an inflation system 322 having the inflation nozzle 382 for inflating the containers, and a sealing device 324 located proximate to the inflation system for sealing closed the inflated containers after inflation. The web 326 comprises a top sheet 325 and bottom sheet 327 sealed together to create inflatable containers between transverse seals 338. This type of machine and the protective packaging material is described for example, in U.S. Pat. App. Pub. 2015/0075114 A1, previously incorporated herein. This machine is generally illustrative of machines for producing protective packaging material of the inflated web, cushion, pillow, and other inflated containers and air-cellular cushioning type, as described in more detail for example, by the previously incorporated references.

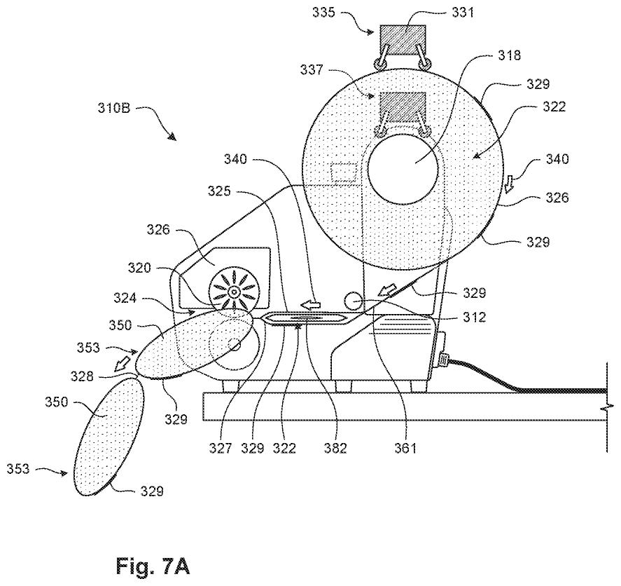

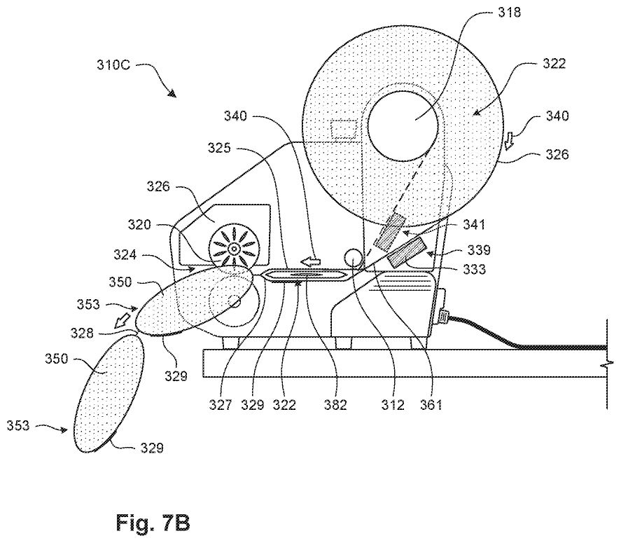

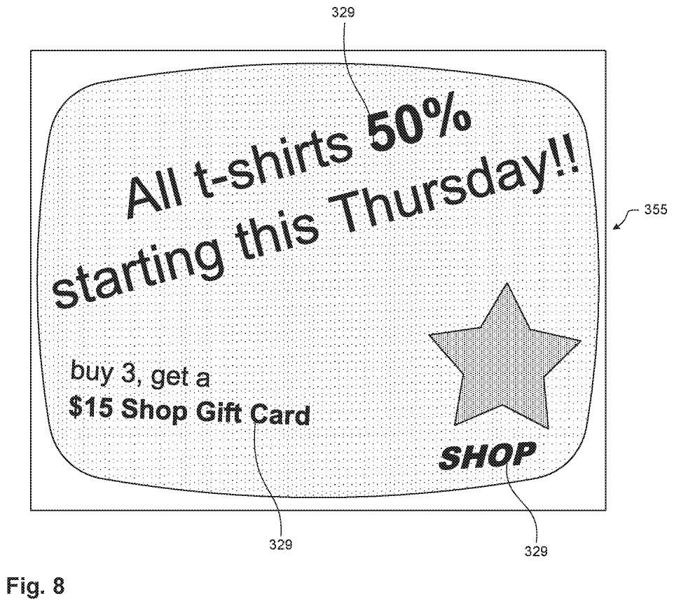

FIGS. 5 and 6 show machine 310A similar to machine 310 of FIG. 4, but having incorporated integrally with the machine 310 a printer 326 positioned downstream from the inflation system 322 and proximate the conveyance system 320 and the sealing device 324. The printer 326 is adapted to receive the targeted information and to affix, in this case print, the targeted information 329 on a component of the protective packaging material, namely, the top sheet 325, as the web is conveyed along the path of travel 340. In accordance with FIG. 3B, in block 218, the machine 310A of FIG. 5, 6 produces the protective packaging material (e.g., inflated containers 350) as the sealing device 324 sealed closed the top and bottom sheets 325, 327 components of the container after inflation by the inflation system 322; and in block 220 of FIG. 3B, affixes the targeted information 329 onto the top sheet component 325 of inflated container 350 to create the targeted protective packaging material, namely printed inflated container 351. FIG. 8 shows printed inflated container 351, which is an exemplary targeted protective packaging material incorporating targeted information 329.

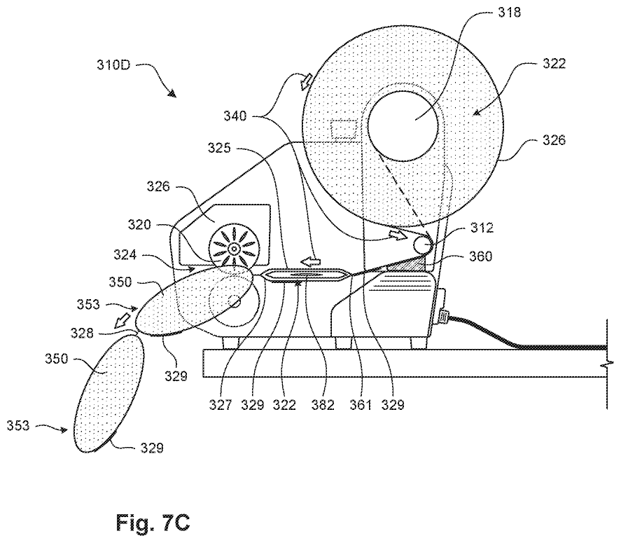

FIG. 7A shows machine 310B similar to machine 310 of FIG. 4, but having incorporated integrally with the machine 310 a printer 331 that is positioned proximate the roll 328. The printer 331 is adapted to receive the targeted information and to affix, in this case print, the targeted information 329 on a component of the protective packaging material, namely, the bottom sheet 327, as the web is unwound from the roll 328. In accordance with FIG. 3A, in block 214, the machine 310B of FIG. 7A affixes the targeted information 329 onto the bottom sheet component 327 of inflatable web 326 to create the targeted protective packaging component, namely printed inflatable web 361. The printed web is conveyed by conveyance system 320 along the path of travel 340 from roll 328 around guide tension rod 312 to inflation system 322 and sealing device 324; whereupon as in block 216 of FIG. 3, the targeted protective packaging component (i.e., printed inflatable web 361) is inflated and sealed to produce targeted protective packaging material (i.e., printed inflated containers 353).

As the inflatable web is withdrawn from roll 328, the diameter of the roll decreases. The printer 331 is adapted to track this decrease in diameter to maintain the printer's proximity to the web so that the printer continues to be able to print on the web as the roll diameter decreases. For example, the printer 331 is movable from first position 335 to second position 337 as the roll diameter decreases. (FIG. 7A.) This may be accomplished by spring loading the printer along a track to bias the printer into contact with the surface of roll 328.

FIG. 7B shows machine 310C similar to machine 310B of FIG. 7A, but having incorporated integrally with the machine 310C a printer 333 downstream from the roll 328 and proximate guide tension rod 312. Printer 333 may be used in addition to, or as alternative to, another printer (e.g., printer 331). The printer 333 is adapted to receive targeted information and to affix, in this case print, targeted information 329 on the bottom sheet 327, as the web passes adjacent the guide tension rod 312. In so doing, this either will create the targeted protective packaging component, namely printed inflatable web 361, if another printer is not used or is not incorporated in the system, or will supplementally print additional targeted advertising information onto the web if targeted advertising information has previously been printed on the web by another printer.

As the inflatable web is withdrawn from roll 328, the diameter of the roll decreases, which changes the contact angle of the web with the guide tension rod 312, as illustrated by the dashed line in FIG. 7B. The printer 333 is adapted to track this change in contact angle to maintain the printer's proximity to the web so that the printer continues to be able to print on the web as the contact angle changes with the roll diameter decrease. For example, the printer 333 may be pivotably mounted to move or rotate from first position 339 to second position 341 as the contact angle of the web decreases as the roll diameter decreases. (FIG. 7B.) This may be accomplished by spring loading the printer 333 to bias the printer into contact with the web.

FIG. 7C shows machine 310D similar to machine 310B of FIG. 7A, but having incorporated integrally with the machine 310D a printer 360 downstream from the roll 328 and proximate guide tension rod 312. Printer 360 may be used in addition to, or as alternative to, another printer (e.g., printer 331). The printer 360 is adapted to receive targeted information and to affix, in this case print, targeted information 329 on the bottom sheet 327, as the web passes adjacent the guide tension rod 312. In so doing, this either will create the targeted protective packaging component, namely printed inflatable web 361, if another printer is not used or is not incorporated in the system, or will supplementally print additional targeted advertising information onto the web if targeted advertising information has previously been printed on the web by another printer.

As the inflatable web is withdrawn from roll 328, the diameter of the roll decreases, which changes the contact angle of the web with the guide tension rod 312, as illustrated by dashed lines in FIG. 7C. Because the printer 360 is located downstream of the tension rod 312, the position of the web with respect to the printer 360 does not change with the changing diameter of the roll 328. Thus, the printer 360 does not need to be adapted to track any change in contact angle of the web to maintain the printer's proximity to the web.

The printers 326, 331, 333, 360 may embody any of those described herein, for example, a digital printer.

FIG. 9 shows packing station 363 where operator 359 has placed previously produced targeted protective packaging material 367 into box 369 to create the package 371 combining the targeted protective packaging material 367 and the corresponding collection of one or more products (not visible) in box 369. The operator 359 has previously used scanner 35 to scan the machine readable code 375 of printed sheet 373 to generate detected information corresponding to the collection 355 of products 357 and communicate the detected information to the system. The system used the detected information to access recipient-specific or product-specific information and select targeted information 329 from stored information to correspond with the collection 355, as described in more detail elsewhere herein. Machine 310A inflated the web 326 of inflatable containers and printer 326 affixed (i.e., printed) the targeted information 329 to produce the targeted protective packaging material, namely, printed inflated containers 351 corresponding with collection 355. The operator will create a package by placing the collection 355 into empty box 365 and installing the printed inflated containers 351 in box 365 as dunnage to take up the void space, cushion, and retain the products 357 in box 365. This process may be repeated for remaining products of a selection of products (not shown) that may be delivered (e.g., by conveyor) to the packing station 363.

### Foam-in-Bag or Foam-in-Place Packaging Systems

We turn now to embodiments where the protective packaging material and machine for making same relates to foam-in-bag or foam-in-place packaging systems, for example as described in more detail by the incorporated references.

By way of background, a foamable composition is formed by mixing an isocyanate compound with a hydroxyl-containing material, such as a polyol (i.e., a compound that contains multiple hydroxyl groups), typically in the presence of water and a catalyst. The isocyanate and polyol precursors react to form polyurethane. At the same time, the water reacts with the isocyanate compound to produce carbon dioxide. The carbon dioxide causes the polyurethane to expand into a foamed cellular structure (i.e., a polyurethane foam), which may be used to protect or cushion a packaged object. It will be understood that foamable compositions can be formed by mixing any number of other chemical combinations that causes expanded foam to form. Such foams may be urethane foams or non-urethane foams.

In “foam-in-bag” packaging, a machine produces flexible containers (e.g., bags) from flexible, plastic film, and dispenses a foamable composition into the containers as they are being formed. As the composition expands into a foam within the container, the container is sealed shut and typically dropped into a carton (e.g., a box), which holds the object to be cushioned. The rising foam expands into the available space within the carton, but does so inside the container. Because the bags are formed of flexible plastic, they form individual custom foam cushions around the packaged objects.

In “foam-in-place” packaging, the cushioning foam is generated while an article to be protected is being packaged. For example, when polyurethane foam precursors are mixed to react and generate the polyurethane foam, by the time that the urethane foam forms and hardens (i.e., “sets”) the resulting foam has expanded to fill the void spaces in the closed container and thereby cushion the object being packaged. As the composition foams to fill the remainder of the closed container, it forms a custom-shaped foam cushion surrounding the object. The object to be packaged may be covered with a polymer film or other material to protect the object from the liquid foamable composition (i.e., a mixture of the reactant precursors) that is injected or dispensed into the container onto the polymer film.

In either system, a dispenser receives, and may initiate mixing of, the foam reactant precursors from (typically) two separate supply containers (e.g., supply drums), then dispenses or injects the reactive mixture. Such systems may operate periodically or on-demand, as an operator or control computing entity actuates the dispenser, thereby periodically activating the pumps to supply the foam precursor liquids.

In a similar manner as described herein with respect to the inflated structures systems, the targeted information may be printed onto a component of the foam-in-bag or foam-in-place protective packaging material, for example, onto the bag or container in which the foam precursors or foaming mixtures is injected or onto the sheet that is placed into the foam-in-place system. In other examples, targeted information may be printed directly onto foam after the foam has set. This may be done by setting the foam in a mold, removing the set foam from the mold, and printing targeted information on the foam before inserting the foam is placed in a package with one or more products.

### Paper Dunnage Systems

We turn now to embodiments where the protective packaging material and machine for making same relates to paper dunnage, for example as described in more detail by the incorporated references.

In the context of paper dunnage protective packaging, rolls of paper sheet are crumpled to produce the dunnage. Most commonly, this type of dunnage is created by running a generally continuous strip of paper into a machine. Typically, paper material is crumpled longitudinally so as to form a long strip of dunnage having many folds or pleats. Because the paper has fold spaces and/or pleats, the crumpled paper can be very effective at protecting and cushioning a product contained within the container, and may effectively prevent damage to the product during transport and/or storage. Upon exiting the machine, the continuous strip of dunnage may extend from the machine and may remain attached to the material still being processed by the machine. The exiting material may require cutting to free it from the dunnage still in the machine and to provide the desired length of dunnage units for use in effectively filling void space within a container holding a product.

The machine may be configured to include a forming assembly for shaping a sheet material into a continuous strip of dunnage having a three-dimensional shape, a pulling assembly for advancing the sheet material through the forming assembly, and a severing assembly for severing the dunnage strip into a severed section of dunnage.

The machine may be configured to convert a sheet stock material into a multi-ply dunnage product. The machine may include a feed mechanism that advances a sheet stock material and a connecting mechanism downstream of the feed mechanism that retards the passage of the sheet stock material by feeding the stock material therethrough at a slower rate than the feed mechanism. The connecting mechanism connects multiple overlapping layers of sheet stock material together as they pass therethrough, including connecting at least one crumpled sheet to one side of another sheet.

The machine may be configured to convert a two-dimensional stock material into a three-dimensional cushioning product. The machine may include a housing through which the stock material passes along a path; and a feeding/connecting assembly which advances the stock material from a source thereof along said path, crumples the stock material, and connects the crumpled stock material to produce a strip of cushioning. The feeding/connecting assembly includes upstream and downstream components disposed along the path of the stock material through the housing, at least the upstream component being driven to advance the stock material toward the downstream component at a rate faster than the sheet-like stock material can pass from the downstream component to effect crumpling of the stock material therebetween to form a strip of cushioning. Additionally, at least one of the upstream and downstream components includes opposed members between which the stock material may be passed and pinched by the opposed members with a pinch pressure; and a tension control mechanism may be provided for adjusting the amount of pinch pressure applied by the opposed members to the stock material.

These types of machines are illustrated, for example, in one or more of U.S. Patent App. Publ. Nos. 2009/0023570 A1 and 2009/0082187 A1, and U.S. Pat. Nos. 7,258,657; 6,783,489; and 6,019,715, previously incorporated herein.

In a similar manner as described herein with respect to the inflated structures systems, the targeted information may be printed onto a component of the protective packaging material, namely the paper or sheet stock, that is converted by the machine to paper dunnage. In other examples, the protective packaging material, namely the paper or sheet stock, is converted by the machine to paper dunnage and then the targeted information is then printed onto a component of the converted protective packaging material.

### Suspension and/or Retention Packaging Systems

We turn now to embodiments where the protective packaging material and machine for making same relates to suspension and/or retention packaging systems, for example as described in more detail by the incorporated references.

Both suspension packaging and retention packaging systems in this context use a frame material (e.g., a corrugated cardboard material) and a sheet material attached thereto (e.g., a plastic film) to facilitate retention or suspension of the packaged product in the container. The targeted information may be printed onto such components of the suspension or retention packaging systems before conversion into the final protective packaging material.

### Exemplary System Architecture—Control Computing Entity

FIG. 2 provides a schematic of a control computing entity 100 according to one embodiment of the presently disclosed subject matter. In general, the terms computing entity, computer, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, televisions, dongles, cameras, wristbands, wearable items, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In an example embodiment, a control computing entity 100 is a tablet coupled to a packing material making machine 150. In another example embodiment, a control entity provides a touchscreen user interface and controller for a packing material making machine 150.

The control computing entity 100 may also comprise, be in communication with, and/or be associated with various other systems, such as a packaging control system 30, an expert computing device 20, and a variety of other systems and their corresponding components.

As indicated, in one embodiment, the control computing entity 100 may also include one or more communications interfaces 120 for communicating with various computing entities, such as by communicating data, content, information, and/or similar terms used herein interchangeably that can be transmitted, received, operated on, processed, displayed, stored, and/or the like.

As shown in FIG. 2, in one embodiment, the control computing entity 100 may include or be in communication with one or more processing elements 105 (also referred to as processors, processing circuitry, and/or similar terms used herein interchangeably) that communicate with other elements within the control computing entity 100 via a bus, for example. As will be understood, the processing element 105 may be embodied in a number of different ways. For example, the processing element 105 may be embodied as one or more complex programmable logic devices (CPLDs), microprocessors, multi-core processors, coprocessing entities, application-specific instruction-set processors (ASIPs), microcontrollers, and/or controllers. Further, the processing element 105 may be embodied as one or more other processing devices or circuitry. The term circuitry may refer to an entirely hardware embodiment or a combination of hardware and computer program products. Thus, the processing element 105 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 105 may be configured for a particular use or configured to execute instructions stored in volatile or non-volatile media or otherwise accessible to the processing element 105. As such, whether configured by hardware or computer program products, or by a combination thereof, the processing element 105 may be capable of performing steps or operations according to embodiments of the present invention when configured accordingly.

In one embodiment, the control computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 110, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In example embodiments, the control computing entity 100 comprises memory 110. The memory 110 may comprise volatile memory and/or non-volatile memory.

In one embodiment, the control computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 110, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 105. Thus, the databases, database instances, database management systems, data, applications, programs, program modules, scripts, source code, object code, byte code, compiled code, interpreted code, machine code, executable instructions, and/or the like may be used to control certain aspects of the operation of the control computing entity 100 with the assistance of the processing element 105 and operating system.

As indicated, in one embodiment, the control computing entity 100 may also include one or more communications interfaces 120 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the control computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol.

The control computing entity 100 may include or be in communication with a user interface 115. The user interface 115 may comprise one or more input elements, such as a keyboard input, a mouse input, a touch screen/display input, motion input, movement input, audio input, pointing device input, joystick input, keypad input, scanner 35, foot switch, and/or the like. The user interface 115 may also include or be in communication with one or more output elements (not shown), such as audio output, video output, screen/display output, motion output, movement output, and/or the like.

As will be appreciated, one or more of the control computing entity's 100 components may be located remotely from other control computing entity 100 components, such as in a distributed system. Furthermore, one or more of the components may be combined and additional components performing functions described herein may be included in the control computing entity 100. Thus, the control computing entity 100 can be adapted to accommodate a variety of needs and circumstances. As will be recognized, these architectures and descriptions are provided for exemplary purposes only and are not limiting to the various embodiments.

### Exemplary Database Computer Entity and Packaging Control System

The database computer entity 20 and/or package control system 30 may include one or more components that are functionally similar to those of the control computing entity 100. In example embodiments, database computer entity 20 and/or package control system 30 may each include one or more processing elements (e.g., CPLDs, microprocessors, multi-core processors, coprocessing entities, ASIPs, microcontrollers, and/or controllers), one or more display device/input devices (e.g., including user interfaces), volatile and non-volatile storage or memory, and/or one or more communications interfaces. For example, a database computer entity 20 may communicate or interact with any number of control computing entities 100 via their respective communication interfaces.

In one or more embodiments, packaging control system 30 may be configured to organize a flow of one or more items to be packaged. For example, the packaging control system 30 may be configured to provide a picking list to one or more employees for picking items to be packaged (e.g., picking the items from a warehouse, etc.), control one or more picking machines for picking items to be packaged, control one or more conveyor belts or other item transporting devices to provide the one or more items to a packaging station, and/or the like. In various embodiments, the packaging control system 30 may be in wired or wireless communication with one or more scanners 35 (e.g., barcode scanners, optical scanners, computer vision devices and/or the like) for identifying, sensing, and/or otherwise determining one or more items to be packed, and with control computing entity 100 as described herein.

As will be recognized, these architectures and descriptions are provided for exemplary purposes only and are not limiting to the various embodiments.

### Computer Program Products, Methods, and Computing Entities

Embodiments of the presently disclosed subject matter may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

Various embodiments of the presently disclosed subject matter may also be implemented as methods, apparatus, systems, computing devices, computing entities, and/or the like. As such, embodiments may take the form of an apparatus, system, computing device, computing entity, and/or the like executing instructions stored on a computer-readable storage medium to perform certain steps or operations. Thus, various embodiments may also take the form of an entirely hardware embodiment, an entirely computer program product embodiment, and/or an embodiment that comprises combination of computer program products and hardware performing certain steps or operations.

Embodiments of the presently disclosed subject matter are described above with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

The above descriptions are those of preferred embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. The definitions and disclosures set forth in the present Application control over any inconsistent definitions and disclosures that may exist in an incorporated reference.

1. A method of packaging a selection of products, the method comprising the following steps:
a) providing a collection of one or more products from the selection of products;
b) receiving information selected from one or more of:
recipient-specific information associated with an intended recipient of the collection; and
product-specific information associated with the collection;
c) selecting targeted information for the collection based on the received information;
d) affixing the targeted information on a protective packaging material to create a targeted protective packaging material; and
e) creating a package combining the targeted protective packaging material and the collection.

2. The method of claim 1 further comprising:
f) repeating the steps a) through e) for the remaining products of the selection of products.

3. The method of claim 1 wherein the selecting step (c) comprises selecting the targeted information from a database of stored information.

4. The method of claim 1 wherein the affixing step (d) comprises one or more of:
affixing the targeted information on a component of the protective packaging material to create a targeted protective packaging component and subsequently producing the targeted protective packaging material to include the targeted protective packaging component; or
producing the protective packaging material to include a protective packaging material component and subsequently affixing the targeted information on the component to create the targeted protective packaging material.

5. (canceled)

6. The method of claim 1, further comprising shipping each package to the corresponding intended recipient of the collection of one or more products.

7. The method of claim 1, further comprising:
providing a machine adapted to produce protective packaging material by combining one or more components of protective packaging material, the machine comprising:
a source of the one or more components of the protective packaging material; and
a printer adapted to receive the targeted information and to print the targeted information on a component of the protective packaging material.

8. (canceled)

9. The method of claim 1, wherein the protective packaging material comprises an inflatable structure.

10. The method of claim 9 wherein:
the protective packaging material comprises an inflatable structure;
the machine is adapted to inflate the inflatable structure with an inflation fluid and to close the inflatable structure to retain the inflation fluid; and
the printer is adapted to print the targeted information on the inflatable structure.

11. The method of claim 9, wherein the inflatable structure includes top and bottom sheets sealed together by transverse seals to define a series of inflatable chambers having an opening between the terminal ends of the transverse seals and proximate a longitudinal edge of the web for receiving inflation fluid, and wherein the printer is adapted to print the targeted information on one or more of the top and bottom sheets of the inflatable structure.

12.-13. (canceled)

14. The method of claim 1 wherein:
the protective packaging material comprises:
a frame defining one or more foldable flaps and a remainder portion of the frame; and
a sheet affixed to the one or more foldable flaps; and
the printer is adapted to print the targeted information on one or more of the frame and the sheet.

15. (canceled)

16. The method of claim 1, wherein the protective packaging material comprises a foam-in-bag assembly.

17. The method of claim 16 wherein:
the protective packaging material comprises:
a bag formed from one or more films; and
one or more foam precursors or the foam generated by reaction of the one or more foam precursors; and
the machine is adapted to:
provide the bag;
dispense the one or more foam precursors into the bag; and
close the bag to retain the one or more foam precursors or the foam generated by reaction of the one or more foam precursors; and
the printer is adapted to print the targeted information on the one or more films of the bag.

18. The method of claim 1, wherein the receiving step further comprises:
sensing one or more products of the collection using a product reader configured to generate detected information corresponding to the sensed one or more products of the collection; and
accessing the recipient-specific information or the product-specific information based on the detected product information.

19.-21. (canceled)

22. The method of claim 1, wherein the targeted information includes targeted advertisement information.

23. The method of claim 22, further comprising using a computer system comprising a processor configured to:
receive the detected product information;
access a database having one or more of (i) the recipient-specific information associated with the detected product information and (ii) the product-specific information associated with the detected product information;
receive targeted advertising information associated with the recipient-specific information or the product-specific information based on advertisement selection criteria; and
provide the targeted advertisement information to the printer for printing on the protective packaging material.

24. The method of claim 23 wherein the processor is further configured to associate targeted advertising information with the recipient-specific information or the product-specific information based on advertisement selection criteria.

25. The method of claim 23, wherein the computer processor is configured to operatively control the printer to print the targeted advertisement information on the component of the protective packaging material to create the targeted protective packaging component.

26. The method of claim 23, wherein the advertisement selection criteria determines the targeted advertisement information based on the product-specific information.

27. The method of claim 23, wherein the advertisement selection criteria determines the targeted advertisement information based on the recipient-specific information.

28. The method of claim 22, wherein the targeted advertising information includes one or more of promotions, sales, discounts, coupons, pricing, availability, timing, physical locations, online locations, product or services performance or descriptions, slogans, trademarks, service marks, and trade names.

29.-31. (canceled)
